(19) United States
(12) Patent Application Publication
(10) Pub. No.: US 2008/0159106 A1
(43) Pub. Date: Jul. 3, 2008

(54) Two-Dimensional Symbol Detector One-Dimensional Symbol Detection

(75) Inventors: Albert Hendrik Jan Immink, Eindhoven (NL); Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,242

(22) PCT Filed: Feb. 28, 2005
(86) PCT No.: PCT/IB05/50720

§ 371 Date: Aug. 22, 2006

(30) Foreign Application Priority Data
Mar. 3, 2004 (EP) 04100841.8

(51) Int. Cl. G11B 20/10

(52) U.S. Cl. 369/59.17

(57) ABSTRACT

The present invention relates to a symbol detection apparatus for detecting the symbol values of a one-dimensional channel data stream recorded along one-dimensional contiguous tracks on a record carrier, wherein the symbols of adjacent tracks have a varying phase relation. In order to enable the use of a 2D symbol detection scheme for symbol detection of the symbol values of a one-dimensional channel data stream, an apparatus is proposed comprising: a phase detection means (31) for detecting the phase relation of the symbols of at least two adjacent tracks, a processing means (30) for determining HF reference levels at the symbol positions of the symbols of said at least two adjacent tracks by recalculating an ideal two-dimensional target HF impulse response (g_{k,2D}) of the symbols of said at least two adjacent tracks, said ideal two-dimensional target HF impulse response (g_{k,2D}) representing an HF impulse response assuming no phase difference between the symbols of said at least two adjacent tracks, based on the detected phase relation, and 2D symbol detection means (6) for symbol detection of the symbols of at least one of said at least two adjacent tracks using said HF reference levels (REF_{k,i}) and HF signal values (HFk_{k,i}) read-out from said record carrier

The present invention relates to a symbol detection apparatus for detecting the symbol values of a one-dimensional channel data stream recorded along one-dimensional contiguous tracks on a record carrier, wherein the symbols of adjacent tracks have a varying phase relation. Further, the present invention relates to a corresponding symbol detection method, a reproduction apparatus and method and to a computer program for implementing said methods.

In two-dimensional optical storage joint detection is performed on more than one bit-row or, more generally, a one-symbol row. Ideally a 2D-Viterbi detector is used for this purpose. To manage complexity the number of rows that are detected by a single Viterbi detector is limited. For practical cases the two-dimensional broad spiral is considered as a concatenation of so-called stripes with only 2 or 3 rows as, for instance, disclosed in European Patent Application 02292937.6 (PHNL 021237). The advantage of this joint detection is that more energy associated with the to-be-detected bit (or symbol) is used in the detection procedure.

Because the above described method offers the advantage that more energy associated with the to-be-detected bit is used in the detection procedure it is desirable to use this method also in the conventional 1D case. At this moment the ‘radial energy or ‘adjacent energy’ is treated as ‘noise’ and is eliminated with the help of cross talk cancellation circuits (e.g. based on Least Mean Square algorithms that minimize cross correlation between adjacent tracks). However when the application of the 2D detector in the 1D case is considered, the following problem appears.

In the conventional case bits are organized in a 1D-format in a spiral along the tangential direction. The bits in the neighbouring track have no relation whatsoever with the bits on the center track that is subject to detection i.e. there is also no fixed phase relation. Although the channel clock during writing is (ideally) constant, the phase relation between neighbouring tracks will change in time (caused by the change in circumference due to the different radii of adjacent tracks). This can be written as ΔO=2πt, with t being the track pitch. For typical values (as an example) t=143 nm the change in circumference ΔO=899 nm. When this is compared to the bit period of 165 nm, it can be seen that in one circumference of the disc a ‘slip’ of 5.4 bits is present between adjacent tracks. This means that locally the phase variation due to this effect is rather slow. Nevertheless it is varying, so that joint detection with a 2D Viterbi detector assuming a static bit ordering cannot be applied. This makes a straightforward application of a 2D detector on a 1D disc format with the intention to benefit from the energy associated with radial cross-talk impossible.

It is an object of the present invention to provide a symbol detection apparatus and method by which a 2D symbol detection scheme can be applied for symbol detection of the symbol values of a one-dimensional channel data stream. Further, a corresponding reproduction apparatus and method as well as a computer program for implementing said methods shall be provided.

This object is achieved according to the present invention by a symbol detection apparatus as claimed in claim 1, comprising:

a phase detection means for detecting the phase relation of the symbols of at least two adjacent tracks,

a processing means for determining HF reference levels at the symbol positions of the symbols of said at least two adjacent tracks by recalculating an ideal two-dimensional target HF impulse response of the symbols of said at least two adjacent tracks, said ideal two-dimensional target HF impulse response representing an HF impulse response assuming no phase difference between the symbols of said at least two adjacent tracks, based on the detected phase relation, and

a 2D symbol detection means for symbol detection of the symbols of at least one of said at least two adjacent tracks using said HF reference levels and HF signal values read-out from said record carrier.

The present invention relates also to a reproduction apparatus for reproduction of a user data stream from a one-dimensional channel data stream recorded on a record carrier, comprising such a symbol detection apparatus for detecting the symbol values of said one-dimensional channel data stream.

A corresponding symbol detection method and a corresponding reproduction method are defined in claims 12 and 14. A computer program for implementing said methods is defined in claim 15. Preferred embodiments of the invention are defined in the dependent claims.

The invention is based on the idea to recalculate the HF reference levels based on the relative phase between the at least two adjacent tracks, i.e. an ideal two-dimensional target HF impulse response is recalculated by use of the phase relation of the symbols of the at least two adjacent tracks detected beforehand. In this way HF reference levels at the symbol positions of the symbols of the at least two adjacent tracks are obtained, said HF reference levels of the at least two adjacent tracks then all having the same phase relation. This allows the use of a 2D symbol detector for symbol detection of the symbols although the symbols are part of a one-dimensional channel data stream. Such a 2D symbol detector has a better performance which can be used to decrease the track pitch or symbol length so that the density on the record carrier can be increased. Alternatively, the 2D symbol detector can be applied to create larger margins (e.g. tilt) during the read out of media that are already present in the market (e.g. for the optical DVD and BD formats).

Preferably, a resampling is used to resample the original, ideal 2D impulse response based on the relative phase information of the tracks in order to determine the HF reference levels. Moreover, also the asynchronous input symbols read out from the record carrier are resampled to synchronous output symbols so that both the HF symbol values as well as the values of the recalculated HF impulse response are available at the same positions. The resampling can be done by use of a look-up table in combination with linear interpolation or can be based on a complete 2D resampling algorithm. Generally, any resampling scheme can be used.

There are two preferred ways of doing the resampling, in particular resampling both the ideal two-dimensional target HF impulse response and the asynchronous input symbols onto lattice points of a physical lattice, or resampling both the ideal target HF impulse response and the asynchronous input symbols onto lattice points of a state lattice. The physical lattice represents the positions at which the symbols are physically located along the at least two adjacent tracks, and the state lattice represents the positions at which the states of the 2D symbol detector are present per definition according to an ideally non-varying 2D lattice. In one of the at least two adjacent tracks the lattice points of the state lattice and of the physical lattice are coincident, while in the other tracks there is an offset in the tangential direction present.

According to a further embodiment updating means are provided for updating the ideal two-dimensional target HF impulse response by use of preliminary symbol values detected by the 2D symbol detection means. Preferably, only the ideal target HF impulse response is updated and the shifting and resampling of this response is used to calculate the other HF reference levels. The advantage is that (slow) variations in the actual channel impulse response can be tracked by the detector in order to have a continuous optimum detection performance. The reason to adapt only the ideal response (and do shifting and resampling afterwards) is that the implementation becomes more simple and known schemes to do this can be applied.

For separate recovery of the timing on the at least two adjacent tracks, first resampling means, in particular using one or more sampling rate converters, are provided and adapted accordingly using one or more phase locked loops. Further, the phase relation of said tracks may be detected from the detected timing by subtracting the input phase signals of the sampling rate converters or by dedicated phase error detectors.

Since the phase relation between the tracks is a slow varying parameter it is allowed to do low-pass filtering on a difference signal representing the difference between the phase of the at least two adjacent tracks. Thus, high frequency phase jitter can be removed, in particular by setting the cut-off of the low-pass filter independently from the bandwidth of the timing recovery loop (although a constraint is that the cut-off must be lower than the PLL bandwidth to have any effect from the low-pass filter)

Furthermore, cross-talk-cancellation means may be provided according to another embodiment for cancellation of cross-talk introduced from neighbouring tracks of the at least two adjacent tracks into them. This will increase the accuracy of the symbol detection.

Generally, any 2D symbol detector can be used as 2D symbol detection means. However, preferably, a Viterbi detector is used, in particular a trellis-based stripe-wise Viterbi detector for iterative stripe-by-stripe symbol detection, where a stripe comprises the at least two tracks. This enables a reliable symbol detection by iterating a stripe-wise symbol detection method, one iteration representing an application of the trellis-based symbol detection method along a stripe. Interference between successive neighbouring symbol rows is preferably taken into account as side information in the computation of the branch metrics of the trellis (for the considered symbol row).

Generally, the symbol detection according to the present invention is applied on the at least two adjacent tracks. Preferably, the phase detection means and the processing means are adapted for working on three adjacent tracks simultaneously. Furthermore, the 2D symbol detection means is, in this case, adapted for a three-row input and either a one-row output or a three-row output. A reason for discarding two rows in the first case is that the expected bit error rate of these outputs is higher, because the joint detection does not take into account the further signal leakage into the neighbouring tracks.

The invention will now be explained in more detail with reference to the drawings in which

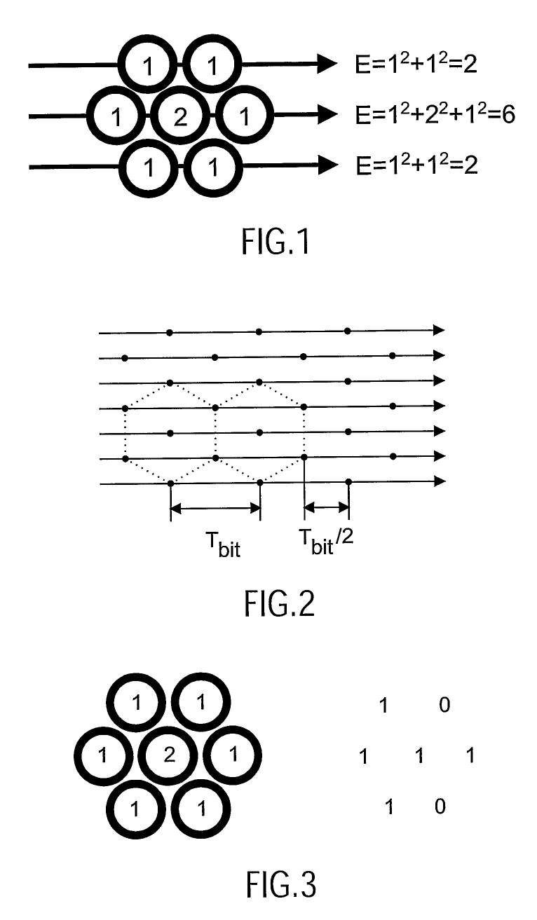

FIG. 1 shows a simple linear model to calculate the energy distribution across different rows/tracks for a particular density of interest,

FIG. 2 a fixed phase relation between symbols on adjacent rows in a hexagonal lattice,

FIG. 3 illustrates the calculation of expected high reference levels based on a simple linear model of the ideal target response,

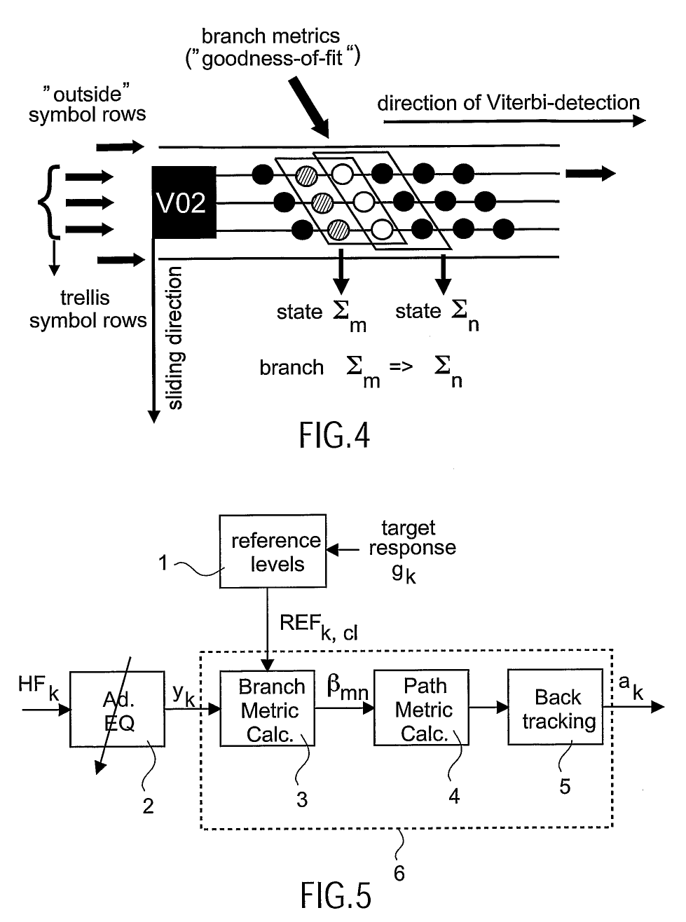

FIG. 4 shows a schematic representation of stripe-wise Viterbi detection,

FIG. 5 a block diagram of a known Viterbi detector with fixed target response,

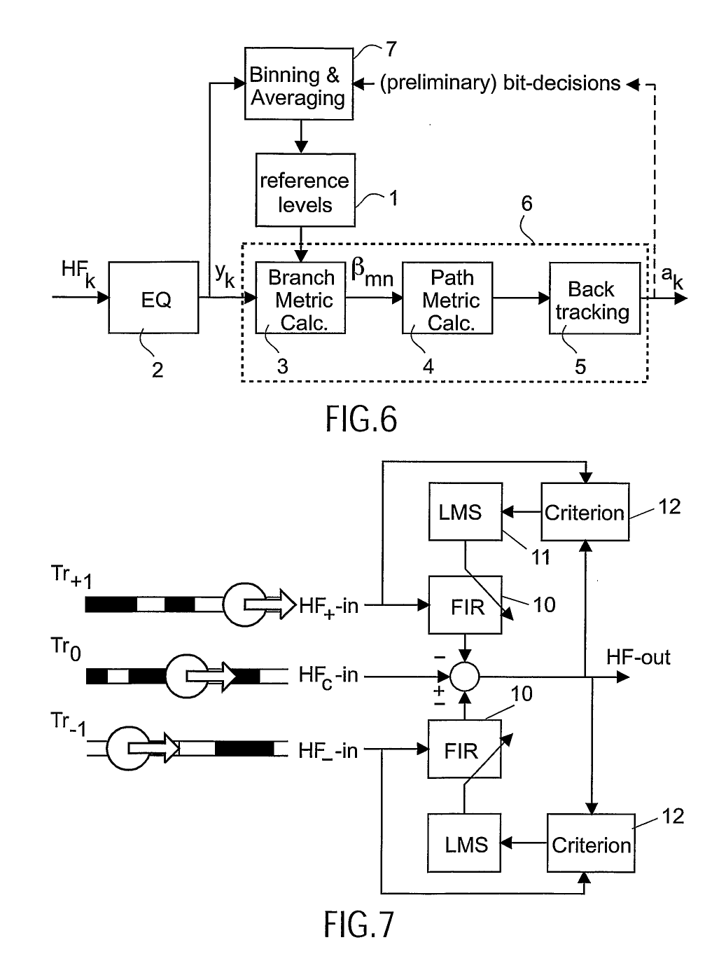

FIG. 6 shows a block diagram of a known Viterbi detector with adaptive reference levels,

FIG. 7 shows a block diagram of a known cross-talk cancellation unit,

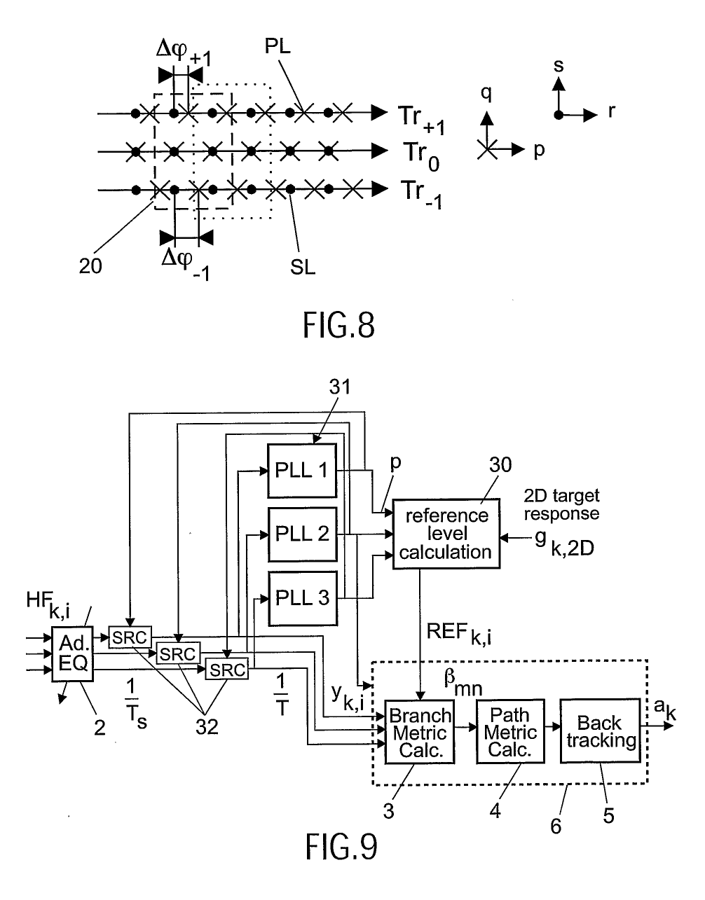

FIG. 8 illustrates the relationship between a state lattice and a physical lattice,

FIG. 9 shows a block diagram of a symbol detection apparatus according to the present invention, which can be used for detection on the physical lattice,

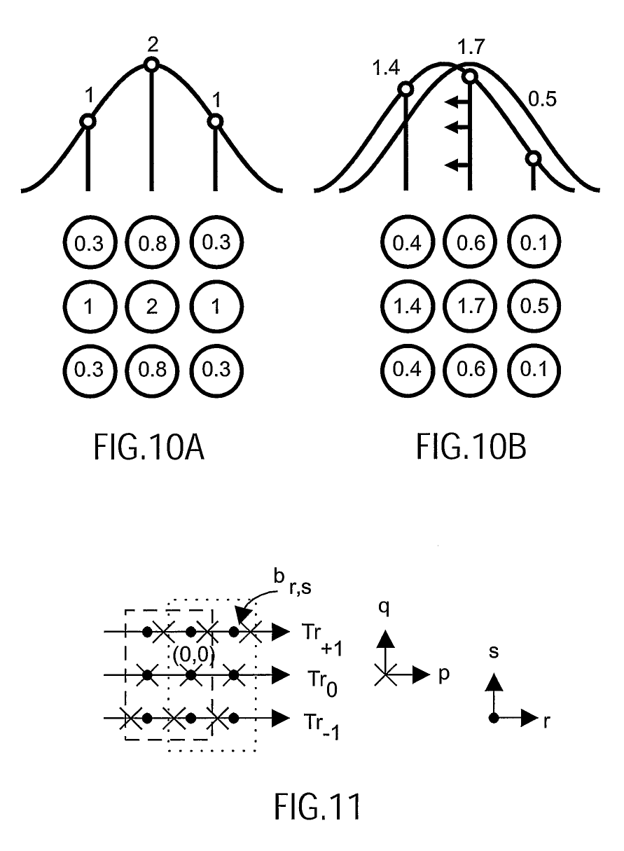

FIG. 10 illustrates the possible result of a shifted 2D HF impulse response,

FIG. 11 illustrates the coordinate definition for calculation of the reference levels,

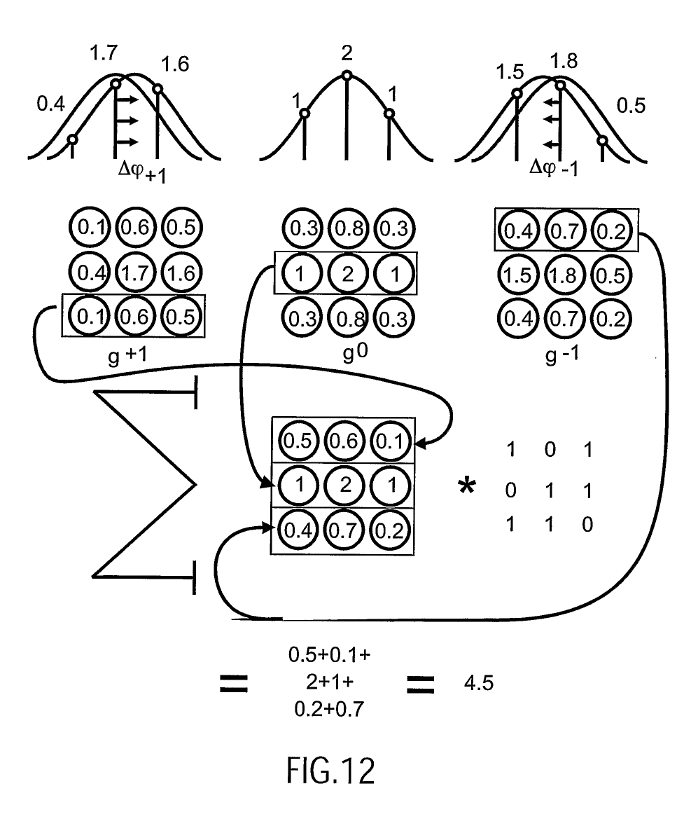

FIG. 12 shows a schematic representation of the reference level calculation for the centre track in case resampling onto a physical lattice is applied,

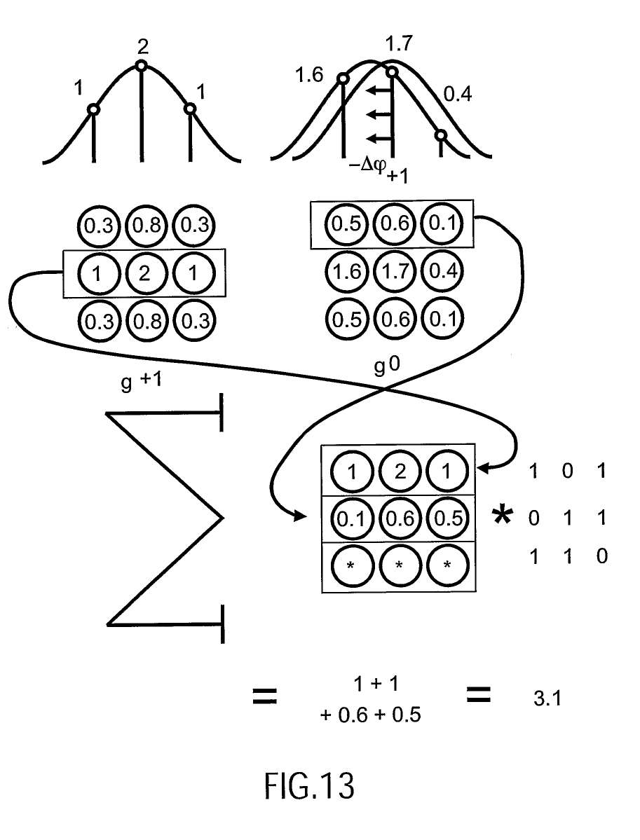

FIG. 13 shows a schematic of the reference level calculation for the outer track in case resampling to a physical lattice is applied,

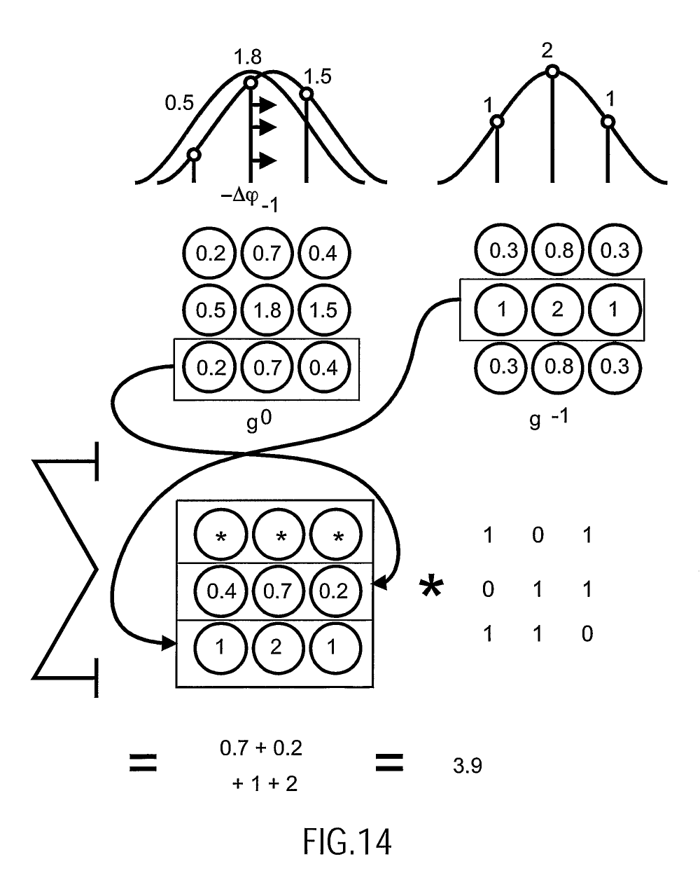

FIG. 14 shows a schematic representation of the reference level calculation for the inner track in case resampling to a physical lattice is applied,

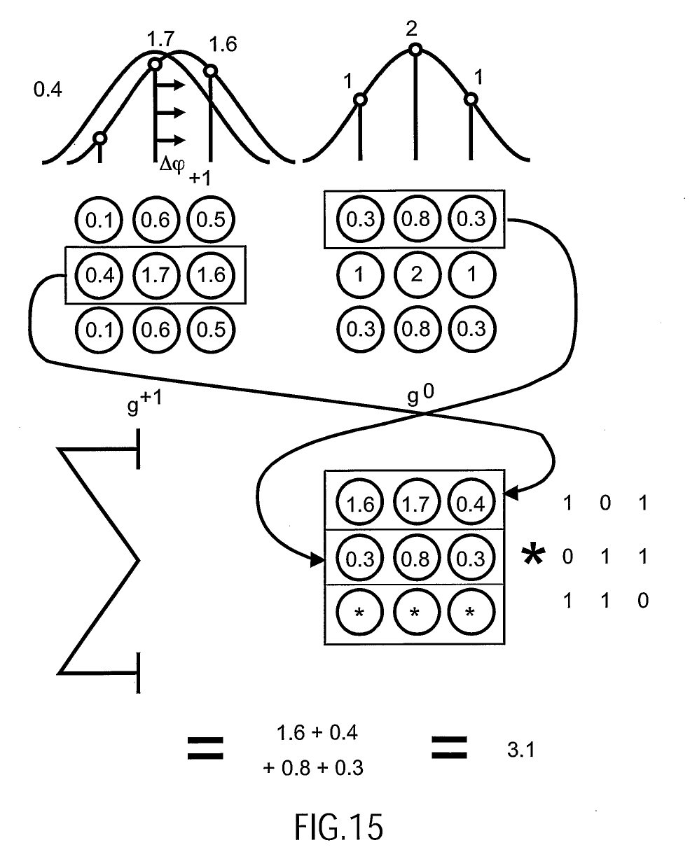

FIG. 15 shows a schematic representation of the reference level calculation for the outer track in case resampling to a state lattice is applied,

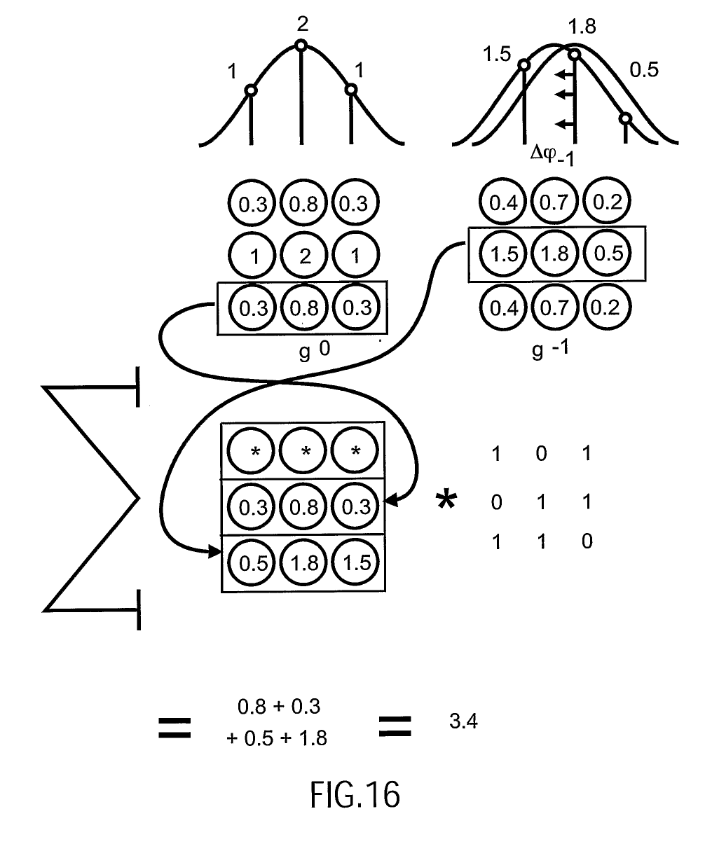

FIG. 16 shows a schematic representation of the reference level calculation for the inner track in case resampling to a state lattice is applied,

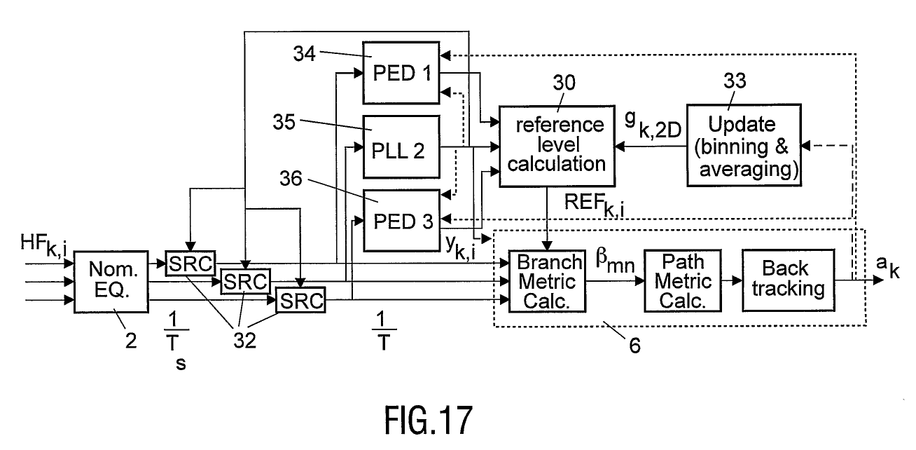

FIG. 17 shows a block diagram of a symbol detection apparatus according to the present invention, which can be used for detection on the state lattice.

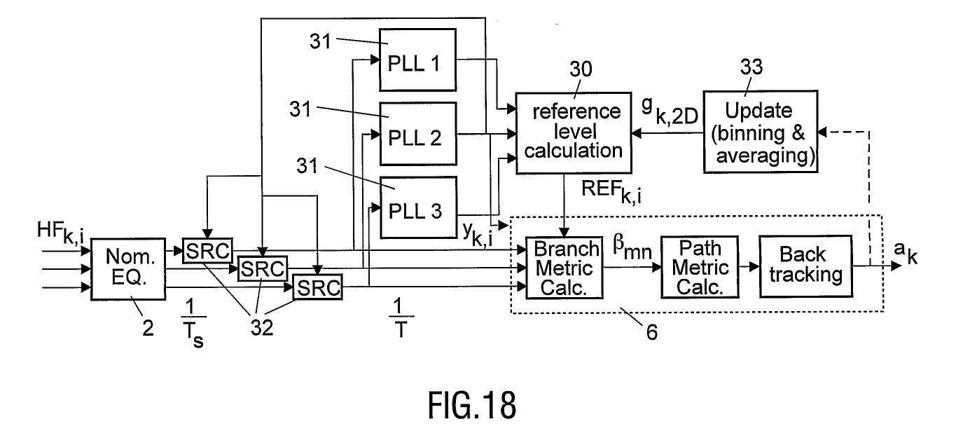

FIG. 18 shows a block diagram of another embodiment of a symbol detection apparatus according to the present invention,

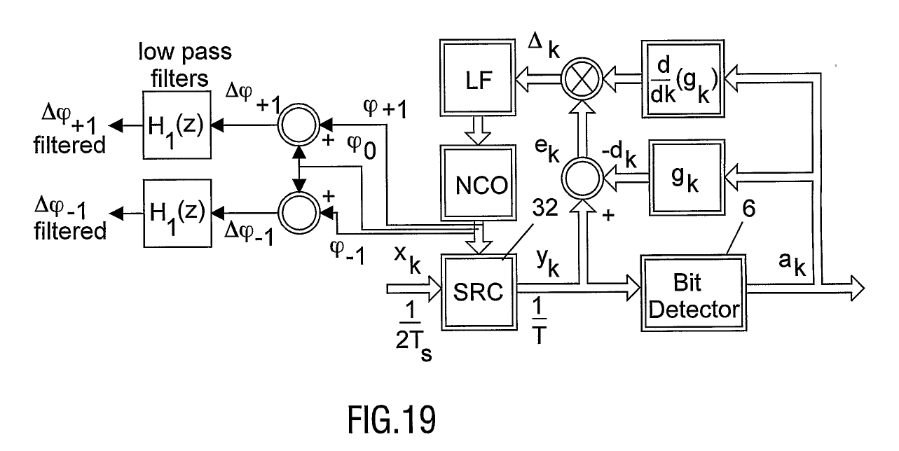

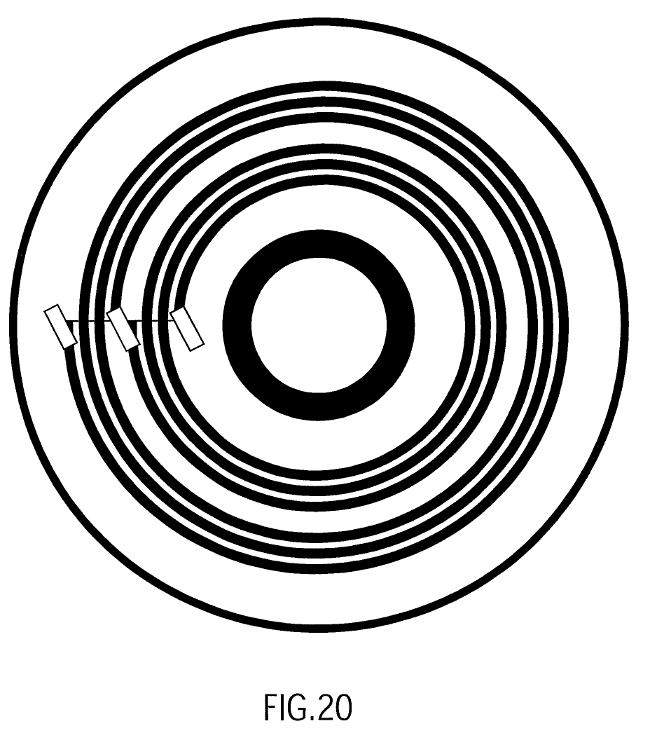

FIG. 19 illustrates a calculation of the phase difference between adjacent tracks and

FIG. 20 illustrates an embodiment of a new 1D single spiral format.

As mentioned above, for high density 2D optical storage as, for instance described in European Patent Application 02292937.6 (PHNL 021237), the symbols of the channel data stream are preferably stored on a hexagonal lattice. The 2D impulse response of the (linearized) channel can be approximated to a reasonable level of accuracy by a central tap with tap value c₀=2, and 6 nearest-neighbour taps with tap value c₁=1. The total energy of this 7-tap response equals 10, with an energy of 6 in the central row along the tangential direction (central tap and two neighbour taps), and an energy of 2 along each of the neighbouring symbol rows in the tangential direction (each with two neighbour taps). This is schematically shown in FIG. 1.

Joint detection in the 2D format works by virtue of the fact that the symbols are ordered on a two-dimensional lattice (preferably a hexagonal lattice because it offers a density advantage over a square lattice). In such a lattice the symbols in the different rows have a fixed phase relation with respect to each other. For the hexagonal lattice the symbols in adjacent rows are shifted by 180 degrees as shown in FIG. 2.

This fixed phase relation allows the definition of so called clusters (set of 7 symbols formed by one central symbol and 6 nearest-neighbouring symbols). The clusters are characterized by the number of nearest-neighbouring symbols that have the same polarity as the central symbol. The expected HF-signal levels (hereinafter also called HF reference levels) can now be calculated by mapping the symbols in the cluster on the 2D impulse response of FIG. 1. This is shown in FIG. 3 for a typical cluster as shown on the right-hand side of this figure.

Stripe-wise Viterbi detection is done by forming a state of a limited number of rows h, and a limited number of symbols in the tangential direction. For instance, 3 rows and 2 symbols are chose in the tangential direction. A trellis is formed by going from one state Σₘ to the next state Σₙ. The two states are partially overlapping each other. This is shown schematically in FIG. 4. The transition from one state to the next is going along a so called branch. A sequence of branches is forming a path through the trellis.

For each branch a cost function (“goodness of fit”) is calculated with the goal to finally select the path that has the lowest cumulative branch cost (called “path cost”) over a limited period of time. This is the path with the “best fit”. This so called “branch metric” β_{m,n} can be calculated as:

$${β}_{mn} = {\sum }_{i = 1}^{h} {\vert H {F}_{i} - {REF}_{i , cl} \vert}^{2}$$

Here HFᵢ is the high-frequency read out signal, i.e. the symbol values of the read-out symbols recorded on the record carrier, and REF_{i,el} is the cluster-dependent reference level which can be calculated according to FIG. 3. This symbol detection method shows good simulation results up to densities of 2.0× BD (Blu-ray Disc).

A block diagram of a known symbol detector is schematically shown in FIG. 5. To calculate the cluster level a preferably fixed (so called) target response gₖ can be used to calculate the reference levels in a calculation unit 1; for instance, the “2-to-1” response of FIG. 1 can be used as target response gₖ. An (adaptive) equalizer 2 is mostly used to convert the incoming replay signal HFₖ to a signal yₖ that matches the target response gₖ as good as possible. Advantageously, for 2D symbol detection the stripe-wise 2D Viterbi symbol detector 6 as described in European Patent Application 02292937.6 (PHNL 021237) is used, comprising a branch metric calculation unit 3 for calculation the branches β_{m,n,} a path metric calculation unit 4 and a back tracing unit 5 for obtaining the output symbol values aₖ.

Another way is to use symbol decisions or preliminary symbol decisions to bin the HF samples HFᵢ according to their corresponding cluster type. There, an additional binning and averaging unit 7 is provided as shown in FIG. 6. The binned samples are averaged over a certain period of time to obtain an expected replay HF value for a particular cluster type that can be used as a reference level in the branch metric calculation. In this way the detector adapts (slowly) to the channel and (partly) replaces the need for an adaptive equalizer 1.

The latter approach can be modified into a procedure where the individual cluster levels are not separately adopted, but where the tap-values for linear and non-linear inter-symbol interference (ISI) are being adapted through channel estimation, from which set of parameters (more limited in number) the individual cluster levels are derived.

As has been explained above, the phase relation of symbols in neighbouring tracks is varying on a disc. Joint detection with a 2D Viterbi detector assuming a static symbol ordering cannot be applied. This makes a straightforward application of a 2D detector on a 1D disc format with the intention to benefit from the energy associated with radial cross-talk impossible.

A first, very straightforward solution would be to define a 1D format that has a fixed phase relation between adjacent tracks. In contrast to the 2D system the data is still organized in single spirals on the disc. Because in each circumference a ‘bit slip’ of a few bits (or symbols; 5.4 bits in the example given above) is present the amount of data that can be stored on one circumference of the disc will decrease for increasing radii. Therefore, it is likely that such a format will be a zoned format, where the zones are separated by so called guard bands. However, this solution has the disadvantage that it cannot be applied on the available 1D formats such as CD, DVD and BD.

A second solution that circumvents the above described disadvantage makes use of multiple spot read-out. In state-of-art cross-talk-cancellation (XTC) schemes, as for instance schematically shown in FIG. 7, the central track Tr₀ is read with a center spot, and adjacent tracks Tr₋₁, Tr₊₁, are read out with additional satellite spots. The resulting signal from the adjacent tracks is filtered and subtracted from the signal from the center spot. Filtering is done with a FIR filter 10 from which the coefficients are adapted in such a way as to minimize cross-correlation between the signal from the center spot and signals from the satellite spots (e.g. using an LMS algorithm 11 based on a criterion 12).

However, when the adjacent signals are available it should be possible to do some joint detection once the phase relation between neighbouring tracks is known and is taken into account in the branch metric calculation. This is the key for the idea of the present invention. Therefore, it is proposed to define two lattices that overlay in the symbol detection region: A state lattice (with indices r,s) and a physical-bit lattice (with indices p,q).

The state lattice is used to define the states of the Viterbi. It is a regular, fixed lattice, for example an orthogonal lattice. It can be any other lattice, but the hexagonal lattice does not offer any advantage in the one-dimensional format (where the actual physical bits are not on the hexagonal lattice) as is the case in the two-dimensional format where it was chosen as the physical lattice due its close-packing property.

The physical lattice is a time varying 2D lattice on which the symbols are stored on the disc. In fact, it is built up of a number (e.g. 3 in case of the below described example) of 1D lines on which the symbols are stored in an equidistant way where the relative phase between the 1D lines can vary. This is schematically shown in FIG. 8. Here the large black dots SL represent the state lattice and the crosses PL define the physical lattice at a particular position on the disc. For the explanation of the idea it is not needed to use more than 3 rows (tracks) although it is possible to extend this idea to more than 3 rows. Furthermore, the idea is also applicable on two adjacent rows. It should be noted that for one particular row (for example the central symbol row) the state lattice and the physical lattice coincide (as will be explained below).

The phase relation between the tracks can be measured by doing timing recovery on each of the tracks separately, resulting in three phases ₋₁, φ₀ and φ₊₁. In fact, the relative phase relation between the tracks is of interest as given by:

Δφ₊₁=φ₊₁−φ₀

Δφ₋₁=φ₋₁−φ₀

The timing recovery can be a conventional zero-crossing based scheme, but can also be working in a decision directed mode using the (preliminary) detected symbols as will be discussed below in more detail. When clock recovery is applied on the center track Tr₀ and when this clock is used for further symbol detection in the Viterbi, the physical symbol vector (as part of the physical lattice) of the center track will exactly coincide with the state lattice, because the sampling rate converter will convert the input samples from the fixed, asynchronous ADC clock Tₛ, to synchronous samples at the symbol frequency T, and symbol phase (of the central track). The coincidence of the lattices on the central track is indicated in FIG. 8. What is also shown in FIG. 8 is that the adjacent tracks Tr₋₁ and Tr₊₁ have a physical lattice that does not coincide with the state lattice.

Now, a 2D Viterbi detector is implemented with 2D states in quite the same way as was done for the two-dimensional scheme (see FIG. 4) with a height of 3 rows/tracks and a total state length of the two overlapping states of 3 in the tangential direction (as an example; other values can also be chosen). This is indicated with the boxes 20, 21 in FIG. 8. The boundaries of the boxes 20, 21 is chosen exactly halfway between the positions on the state lattice. It can be seen that in the upper track and the lower track there are always 3 physical symbol positions (when one is coming in on the left, one falls off on the right). Because clock recovery is performed on the adjacent tracks Tr₋₁ and Tr₊₁ HF samples at the position of the physical symbols on the disc are obtained. The recovered clocks from adjacent tracks have nearly the same frequency as the clock obtained from the central track, but they might differ considerably in phase. The phase information is used indirectly in the symbol detection by recalculating the reference levels based on the relative phase between the 3 tracks as indicated with the above equations for Δφ₊₁ and Δφ₋₁. A block diagram of this scheme with three phase locked loops (PLLs) 31 and three sampling rate converters (SRC) 32 to do timing recovery is shown in FIG. 9.

So the input to the reference calculation block 30 is the ideal 2D target response g_{k,2D} assuming no phase difference between the tracks and 3 phase inputs p resulting from timing recovery on each track separately as indicated in the above equations for Δφ₊₁ and Δφ₋₁. The original, ideal 2D impulse response can be resampled based on the relative phase information p of the tracks. This can either be a look-up table in combination with linear interpolation or a complete 2D resampling algorithm, e.g. based on insertion of zeros and then 2D low-pass filtering to interpolate the missing samples, or any other 2D resampling scheme. There are two possibilities to do resampling:

resampling both the reference signal (using second resampling means) and the input signal (using first resampling means) to the physical lattice, or

resampling both the reference signal (using second resampling means) and the input signal (using first resampling means) to the state lattice.

Both options will be separately discussed below. In any case resampled versions of the 2D target response g_{k,2D} shifted along the track direction will be needed. An example of an original 2D impulse response and a resampled 2D impulse response is given in FIG. 10. To make it more clear a 1D cut is visualized through the 2D target response. Here a possible 2D impulse response on an orthogonal lattice shown in FIG. 10A is shifted and resampled to obtain the resampled 2D impulse response shown in FIG. 10B.

First, resampling on the physical lattice shall be described. In this case the states are in fact defined on the sampling/physical lattice. First, the equation to calculate the branch metrices is considered again (if the number of rows in the stripe is 3):

$${β}_{mn} = {\sum }_{q = - 1}^{+ 1} {\vert H {F}_{q} - {REF}_{p , q , m , n} \vert}^{2}$$

The coordinates have been changed to adapt it to the discussion that is following. Here p,q are the indices of the physical lattice where q is the row-number and p is the coordinate along the tracks (at the position of the overlap of the states p=0). Three HF samples and three reference levels are needed, when the states have one symbol overlap in the tangential direction. Each reference level is the sum of the contributions from each symbol b_{r,s} in the overlapping states Σₘ and Σₙ of the Viterbi (see FIG. 11):

REF_{p,q,m,n}=Σ_{r,sε(Σ,,,UΣ,,)}br,s,m,n·g⁵_{p-r,q-s}(φₛ−φ_{q})

Where g⁵ᵢⱼ (Δφ) is a version of the target response for track s that is shifted over Δφ and sampled at position ij, and φₛ is the phase of tracks. The coordinates p,q and r,s are chosen such that the origin (0,0) coincides with the center symbol position (see FIG. 10). Furthermore, b_{r,s,m,n} is a bit at index (r,s) belonging to a particular branch from Σₘ to Σₙ. (It should be noted that the indices are not used as physical coordinates but as integer numbers that really serve as an index). The above calculation must be done for any position (p,q) for which a reference signal is needed. In this way energy leakage of the central track towards the adjacent tracks is incorporated, but also energy leakage from the adjacent track to the central track is taken into account. This operation must be done for each sample at the input of the detector (i.e. for each clock period T). However, this should be possible to implement without increasing hardware complexity and silicon area in case of an IC too much. To make the calculation more clear it is depicted schematically in FIG. 12 for the calculation of the reference value of the center track. For the outer track and inner track the same calculations are depicted in FIG. 13 and FIG. 14, respectively. It should be noted that the samples are just estimated numbers (for purpose of explanation); actual resampled values might be different from these values.

Now that the reference levels are available on the physical lattice, the HF samples are needed on the same lattice. For the central track this is simple: The input signal is resampled at exactly the correct phase, and the input samples can be used directly. For the adjacent tracks a similar reasoning is valid: The samples of adjacent rows are the result of timing recovery, so they are ideally positioned at the symbol moments and also here they can be used directly (see FIG. 9).

Next resampling on the state lattice shall be described. When the procedure shall be reformulated to a resampling on the state lattice the following can be written:

$${β}_{mn} = {\sum }_{s = - 1}^{+ 1} {\vert H {F}_{s} - {REF}_{r , s , m , n} \vert}^{2}$$

where

REF_{r,s,m,n}=Σ_{p,qε(Σ,,,Uρ,,)}b_{p,q,m,n}·g^{q}_{p-r,q-s}(φ_{q}−φ₀)

The indices r,s and p,q are interchanged to reflect the resampling to another lattice. The corresponding figures for this calculation for the outer track and the inner track are FIG. 15 and FIG. 16. The corresponding figure for the center track is identical to FIG. 12 (because this track was chosen as the reference track where the state and physical lattice coincide).

Because the reference levels are now available on the state lattice, also the HF samples must be obtained at the state lattice. This can be done by taking only one PLL 33 on the reference (here center) row and use the phase information of this PLL 33 to do sampling rate conversion on each of the tracks in such a way that all samples at the output of the SRCs 32 are on the state lattice. Two additional phase error detectors (PEDs) 34, 36 are now needed to derive the phase difference of the other tracks (here outer tracks) with respect to the reference track (here center track). This configuration is schematically shown in FIG. 17. It is also possible, although more complex from hardware point of view, to keep the configuration of FIG. 9, but to add two additional SRCs in series with the SRCs 32 of the outer rows to convert the samples from the physical lattice to the state lattice based on relative phase information derived from the three PLLs 31 (of the embodiment shown in FIG. 9) by subtracting the phase values.

Generally, the phase detection means can be similar to the phase detection means of the PLL. However, in case of the PLL the phase error is taken from the input the SRC (=output of the NCO) because this phase signal is neatly normalized to the synchronous symbol period T. Therefore, an absolute error signal can be extracted without any additional effort. When a phase detection means is applied that is similar to the phase detector of the PLL (i.e. a phase detector using a so-called signature signal), a good phase error signal is obtained, but it is not directly normalized to the symbol period T. It has to be taken care that this normalization is done explicitly. This can be a complete PLL where the output of the SRC is not fed to the 2D detector but is only used as part of the loop to detect the phase.

Furthermore, there needs to be some sort of reference, e.g. a subtraction unit for subtracting the input of the SRCs. But it can also be a reference input in the form of the symbols ak, i.e. data aided phase detection, as indicated in FIG. 17 by dashed lines going either from ak to the phase detectors or from the central PLL to the phase detectors.

The block diagram of the solution as presented in FIG. 9 is the equivalent of the 2D joint detection as presented in FIG. 5. Of course it is also possible to continuously update the reference levels as was shown in FIG. 6. The equivalent of this scheme is shown in FIG. 18. Again symbol decisions or preliminary symbol decisions can be used by an updating unit 33 to update the 2D response that serves as a basis for reference level calculation.

It can be seen that only one 2D target response is updated and that the shifting and resampling of this response is used to calculate the other reference levels. To bin all samples for various states and phase difference does not seem feasible because the large number of bins would ‘dilute’ the number of samples over which averaging can take place, at least when reasonable time constants are required for reference level adaptation.

It is known that for the central track the physical lattice and the state lattice coincide by definition because the recovered clock of this track is used for further symbol detection. Furthermore, the phase difference between the tracks can simply be extracted by subtracting the input of the SRCs (the input signal of the SRC is simply the current phase on which it has to resample the symbols) or by dedicated phase error detectors (PEDs). Because it is known that the phase relation between the tracks is a slow varying parameter it is allowed to do low pass filtering on this signal by a digital filter H1(z). This might be beneficial to remove high-frequency phase jitter that is present in each track and thus also in the relative phase between the tracks. This is shown schematically in FIG. 19. Here a decision directed timing recovery scheme is used. In this figure each wide arrow is a vector of more than one signal, and each single line is a single signal. Also the blocks with a double line (e.g. the loop filter LF, numerically controlled oscillator NCO, . . .) are multiple instantiations of the same circuit. In this figure, d/dk(gₖ) is the derivative of the target response in the form of a FIR filter.

Because joint detection is applied on a limited number of 3 rows Tr₋₁, Tr₀ and Tr₊₁, detection is still done in a sub-optimal way. Because extension of the principle to more rows will lead to a large increase in signal processing complexity it is not a likely step, although not an impossible step. However, there is a possibility to do conventional cross-talk cancelation (XTC) as explained in FIG. 7 for the two tracks that are beyond the boundaries of the stripe-based Viterbi with 3 rows. This means that also further tracks Tr₋₂ and Tr₊₂ must be read from the record carrier In a 1D single spiral format with “joint detection with three row input and three row output”, there is a way to avoid the use of two extra spots, for XTC with Tr₊₂ and Tr₋₂. Such a format is shown in FIG. 20. Each three revolutions of the spiral, the track pitch is very locally changed into a substantial larger value, e.g. 1.5 symbol rows, hereby creating a guard band between each three revolutions and removing the need for an XTC. However, in such a format, it needs to be known beforehand how many symbol rows will be read-out at once.

When starting to use the above described scheme for symbol detection there are two possibilities:

joint detection with one-row output and three-row input, and

joint detection with three-row output and three-row input.

In fact, in the first case also detection is done for all the rows, but only the center row is used as a valid output. The binary outputs of the adjacent tracks are just discarded. A reason for discarding the adjacent rows is that the expected bit error rate of these outputs is higher, because the joint detection does not take into account the further signal leakage into tracks Tr₊₂ and Tr₋₂. Furthermore, the problem of ‘symbol-slips’ will occur. Because the different tracks contain a different number of symbols on one circumference as was indicated above a number of times per revolution a symbol slip in the adjacent tracks will occur. There are two situations:

symbol slips in the outer track Tr₊₁ causing missing symbols in the trellis of the Viterbi, and

symbol slips in the inner track Tr₋₁ causing duplicated symbols in the trellis of the Viterbi.

It is possible to pinpoint the positions of these symbol slips exactly by looking at the phase differences Δφ₊₁ and Δφ₋₁. At the positions of the symbol slips the phase will go from +π to −π or vice versa depending on the ‘missing symbol’ situation or the ‘duplicated symbol’ situation (here the low-pass filtering of the phase differences as suggested in FIG. 19 might be beneficial because otherwise a lot of transitions would occur in a burst due to phase jitter in the tracks).

In case of detection with a one row output the symbol-slips do not cause any problem, because only the output of the center row is used. However, when a three row-output is required some action should be taken to guarantee a proper working of the symbol detection in the Viterbi. If no modulation code was present, the Viterbi detector would simply detect some symbols in the adjacent tracks twice or detect some symbols not at all, causing symbol errors for the adjacent tracks. The duplicated symbols are detected twice and with the use of the phase information (transitions +π to −π), it is possible to skip these symbols. However, for the missing symbols the value of this missing symbol cannot be determined (although the exact position of the missing symbols is known from the phase information). A solution to this problem can be found in the ECC by filling in erasures at the positions of the missing symbols. Because this situation only occurs a few times in one revolution of the disc it will not deteriorate the performance of the ECC so much (here filtering of the phase error is beneficial, because otherwise a burst of alternating missing and duplicated symbols might be present due to phase jitter in each track and ECC performance would deteriorate).

The situation becomes more complex in case of encoded data. When the data is modulation encoded with a modulation encoder (e.g. a EFM or 17PP encoder) the trellis of the Viterbi reflects this modulation code by offering no branches for states that would violate the constraints of the code (in particular the d-constraint). This means that when a symbol is detected twice or detected not at all in one of the adjacent tracks the branches that lead to violation of the code constraints have to be reconsidered. If this is not done, some error-propagation might occur.

The present invention can be applied in drives for the currently known formats like CD, DVD and BD to act as an alternative for cross talk cancellation (XTC). Furthermore, the invention can be applied in new formats (like Portable Blue) where the better performance of the 2D detection can be used to decrease the track pitch or symbol length as to increase the density on the small disc.

1. Symbol detection apparatus for detecting the symbol values of a one-dimensional channel data stream recorded along one-dimensional contiguous tracks on a record carrier, wherein the symbols of adjacent tracks have a varying phase relation, comprising:
a phase detection means (31) for detecting the phase relation of the symbols of at least two adjacent tracks,
a processing means (30) for determining HF reference levels at the symbol positions of the symbols of said at least two adjacent tracks by recalculating an ideal two-dimensional target HF impulse response (g_{k,2D}) of the symbols of said at least two adjacent tracks, said ideal two-dimensional target HF impulse response (g_{k,2D}) representing an HF impulse response assuming no phase difference between the symbols of said at least two adjacent tracks, based on the detected phase relation, and
a 2D symbol detection means (6) for symbol detection of the symbols of at least one of said at least two adjacent tracks using said HF reference levels (REF_{k,i}) and HF signal values (HF_{k,i}) read-out from said record carrier.

2. Symbol detection apparatus as claimed in claim 1, further comprising a first resampling means (32) for resampling asynchronous input symbols (HF_{k,i}) read-out from said record carrier to synchronous output symbols (y_{k,i}) and wherein said processing means (30) comprises a second resampling means for recalculating said ideal two-dimensional target HF impulse response (g_{k,2D}) by a resampling.

3. Symbol detection apparatus as claimed in claim 2, wherein said second resampling means (30) is adapted for resampling the ideal two-dimensional target HF impulse response (g_{k,2D}) onto lattice points of a physical lattice, the lattice points of said physical lattice representing the symbol positions of said at least two adjacent tracks, and wherein said first resampling means (32) is adapted for resampling the asynchronous input symbols (HF_{k,i}) from said at least two adjacent tracks onto the lattice points of said physical lattice based on the output of said phase detection means (31)

4. Symbol detection apparatus as claimed in claim 2, wherein said second resampling means (30) is adapted for resampling the ideal two-dimensional target HF impulse response (g_{k,2D}) onto lattice points of a state lattice, the lattice points of said state lattice representing positions having a fixed phase relation at said at least two adjacent tracks, and wherein said first resampling means is adapted for resampling the asynchronous input symbols (HF_{k,i}) from said at least two adjacent tracks onto to lattice points of said state lattice based on the output of said phase detection means (31) for one particular reference track of said at least two adjacent tracks.

5. Symbol detection apparatus as claimed in claim 1, further comprising updating means (33) for updating said ideal two-dimensional target HF impulse response (g_{k,2D}) by use of preliminary symbol values detected by said 2D symbol detection means (6).

6. Symbol detection apparatus as claimed in claim 2, wherein said first resampling means (32) is adapted for separate recovery of the timing on said at least two adjacent tracks, in particular using one or more sampling rate converters, and for detecting the phase relation of said tracks from the detected timing.

7. Symbol detection apparatus as claimed in claim 1, wherein said processing means comprises a low-pass filter (H₁) for filtering a difference signal representing the difference between the phase of said at least two adjacent tracks.

8. Symbol detection apparatus as claimed in claim 1, further comprising a cross-talk cancellation means (10, 11, 12) for cancellation of cross-talk introduced from neighbouring tracks of said at least two adjacent tracks into said at least two adjacent tracks.

9. Symbol detection apparatus as claimed in claim 1, wherein said 2D symbol detection means (6) comprises a Viterbi detector, in particular a trellis-based stripe-wise Viterbi detector for iterative stripe-by stripe symbol detection, a stripe comprising said at least two tracks.

10. Symbol detection apparatus as claimed in claim 1, wherein said phase detection means (31) is adapted for detecting the phase relation of the symbols of three adjacent tracks, and wherein said processing means (30) is adapted for determining HF reference levels at the symbol positions of the symbols of said three adjacent tracks.

11. Symbol detection apparatus as claimed in claim 10, wherein said 2D symbol detection means (6) is adapted for symbol detection of the symbols of said three adjacent tracks.

12. Symbol detection method for detecting the symbol values of a one-dimensional channel data stream recorded along one-dimensional contiguous tracks on a record carrier, wherein the symbols of adjacent tracks have a varying phase relation, comprising the steps of:
detecting the phase relation of the symbols of at least two adjacent tracks,
determining HF reference levels (REF_{k,i}) at the symbol positions of the symbols of said at least two adjacent tracks by recalculating an ideal two-dimensional target HF impulse response (g_{k,2D}) of the symbols of said at least two adjacent tracks, said ideal two-dimensional target HF impulse response (g_{k,2D}) representing an HF impulse response assuming no phase difference between the symbols of said at least two adjacent tracks, based on the detected phase relation, and
symbol detection of the symbols of at least one of said at least two adjacent tracks using said HF reference levels (REF_{k,i}) and HF signal values (HF_{k,i}) read-out from said record carrier by use of a 2D symbol detection means (6).

13. Reproduction apparatus for reproduction of a user data stream from a one-dimensional channel data stream recorded on a record carrier, comprising a symbol detection apparatus as claimed in claim 1 for detecting the symbol values of said channel data stream.

14. Reproduction method for reproduction of a user data stream from a one-dimensional channel data stream recorded on a record carrier, comprising a symbol detection method as claimed in claim 12 for detecting the symbol values of said channel data stream.

15. Computer program comprising program code means for causing a computer to carry out the steps of the method as claimed in claim 12 when said computer program is run on a computer, Two-dimensional symbol detector for one-dimensional symbol detection
